(19) United States
(12) Patent Application Publication
(10) Pub. No.: US 2014/0198447 A1
(43) Pub. Date: Jul. 17, 2014

(54) HEAT DISSIPATION DEVICE FOR MEMORY CARDS

(71) Applicants: Hon Hai Precision Industry Co., Ltd., New Taipei (TW); Hong Fu Jin Precision Industry (ShenZhen) Co., Ltd., Shenzhen (CN)

(72) Inventor: FANG TIAN, Shenzhen (CN)

(21) Appl. No.: 13/912,213

(22) Filed: Jun. 7, 2013

(30) Foreign Application Priority Data
Jan. 11, 2013 (CN) 2013100102886

(51) Int. Cl. G06F 1/20

(52) U.S. Cl. CPC G06F 1/20
USPC 361/679.32; 165/121

(57) ABSTRACT

A heat dissipation device for a number of memory cards includes two positioning frames, a supporting bracket located above the memory cards, a fan, and four latching members. The memory cards are connected a number of memory slots. The positioning frames are mounted to opposite ends of the memory slots. The supporting bracket includes a supporting plate defining an air ventilation area aligning with the memory cards, and two mounting portions protruding from two opposite ends of the supporting plate. The fan is mounted on the supporting plate and aligning with the air ventilation area. Each mounting portion includes a first end and an opposite second end. Each latching member includes a connecting pole and a latching pole. The connecting poles are engaged with the first and second ends of the mounting portions, and the latching poles are engaged with opposite ends of the positioning frames.

### BACKGROUND

1. Technical Field

The present disclosure relates to a heat dissipation device for cooling memory cards.

2. Description of Related Art

It is well known that many electronic systems comprising many memory cards generate a large amount of heat. If the heat is not removed rapidly, it will cause damage to the memory cards.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a heat dissipation device, together with a motherboard and a plurality of memory cards.

FIG. 2 is similar to FIG. 1, but viewed from another perspective.

FIG. 3 is an enlarged view of the circled portion III of FIG. 1.

FIG. 4 is an enlarged cross-sectional view of one positioning frame of the heat dissipation device of FIG. 1, taken along the line IV-IV thereof.

FIG. 5 is an assembled view of FIG. 1.

FIG. 6 is similar to FIG. 5, but shows the heat dissipation device together with a different motherboard having fewer memory cards.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references can mean “at least one.”

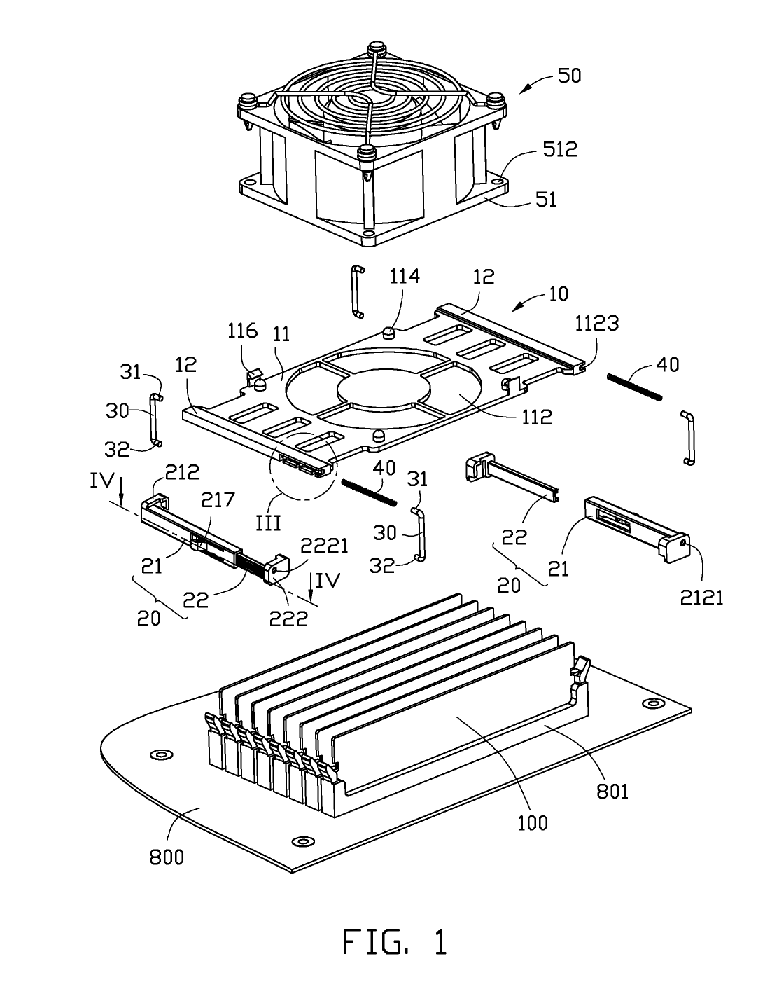

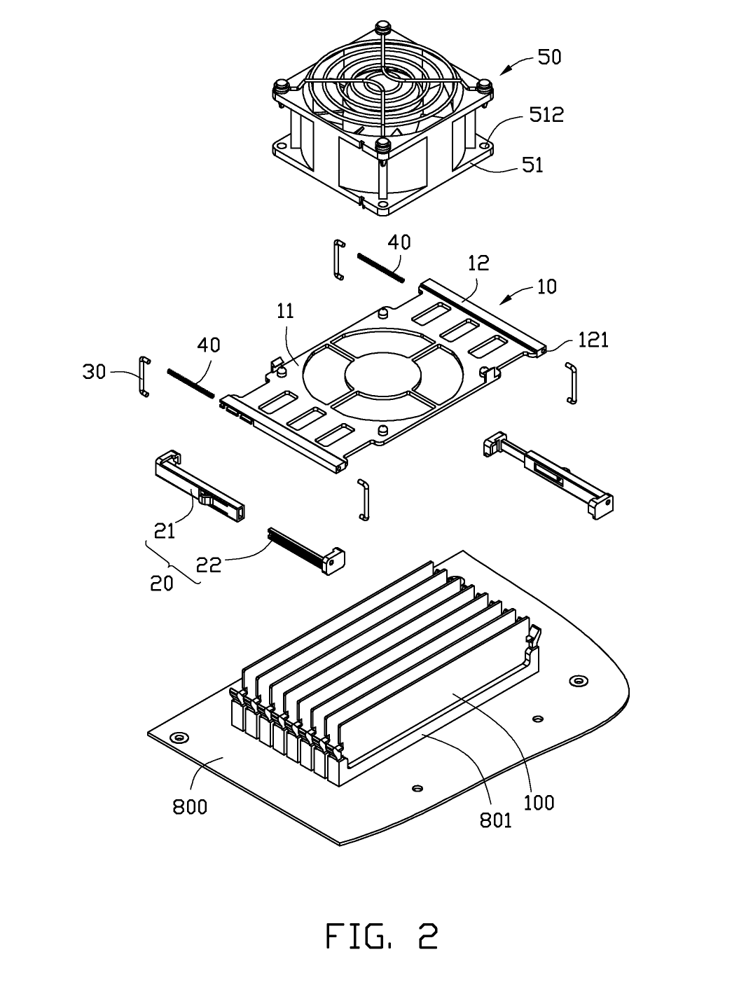

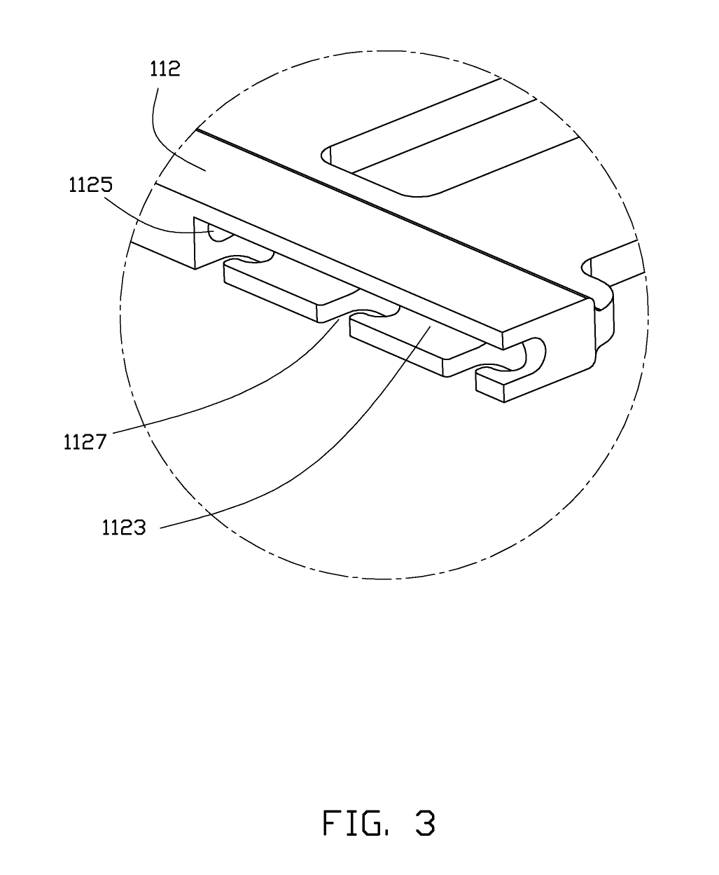

FIGS. 1 to 3 show an embodiment of a heat dissipation device for cooling a plurality of memory cards, in this example memory cards 100. The memory cards 100 are connected to a plurality of memory slots 801 mounted on a motherboard 800. The heat dissipation device includes a supporting bracket 10, two positioning frames 20, four substantially C-shaped latching members 30, two springs 40, and a fan 50.

The supporting bracket 10 includes a substantially rectangular supporting plate 11, and two bar-shaped mounting portions 12 protruding out from two opposite ends of the supporting plate 11. A middle of the supporting plate 11 defines an air ventilation area 112. Four positioning posts 114 protrude up from the supporting plate 11, at four corners of a portion of the supporting plate 11 surrounding the air ventilation area 112. Two resilient hooks 116 protrude up from two opposite sides of the supporting plate 11, adjacent to two diagonally opposite positioning posts 114. A first end of each mounting portion 12 longitudinally defines a mounting hole 121. A second end of each mounting portion 12 opposite to the first end longitudinally defines a receiving slot 1123. Each receiving slot 1123 extends through a longitudinal side surface of the corresponding mounting portion 12 opposite to the supporting plate 11 and an end surface at the second end of the mounting portion 12. An end of the receiving slot 1123 adjacent to the first end of the mounting portion 12 defines a positioning hole 1125 communicating with the receiving slot 1123. A bottom wall bounding each receiving slot 1123 defines a plurality of substantially L-shaped cutouts 1127 arrayed in an extending direction of the receiving slot 1123, and each cutout 1127 communicates with the receiving slot 1123.

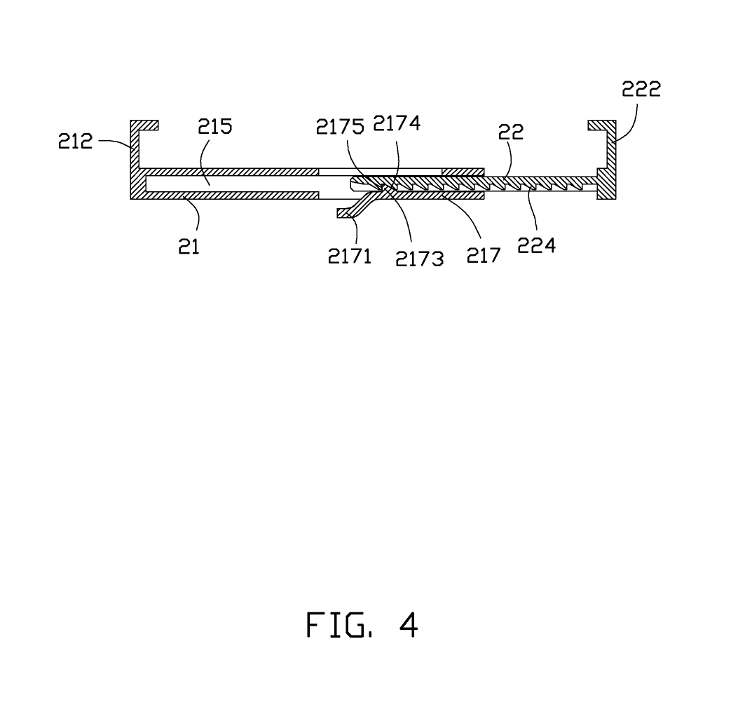

FIG. 4 shows one of the positioning frames 20. The positioning frame 20 includes a first sliding pole 21, and a second sliding pole 22. A clamping portion 212 perpendicularly protrudes from a first end of the first sliding pole 21. The clamping portion 212 defines a positioning hole 2121 in an outer surface thereof opposite to the side of the clamping portion 212 where the first sliding pole 21 is located. An opposite second end of the first sliding pole 21 longitudinally defines a slide slot 215. A resilient arm 217 is formed on an outer side of the first sliding pole 21 opposite to the side of the first sliding pole 21 from which the clamping portion 212 protrudes. An operation portion 2171 protrudes out from a distal end of the resilient arm 217, and a wedged latching block 2173 protrudes from the distal end of the resilient arm 217 and extends into the slide slot 215. The latching block 2173 includes a slanting guiding surface 2174 facing away from the first end of the first sliding pole 21, and a stopping surface 2175 adjacent to the operation portion 2171. The stopping surface 2175 is substantially perpendicular to an extending direction of the slide slot 215. A clamping portion 222 perpendicularly protrudes from an end of the second sliding pole 22 in a same direction that the clamping portion 212 protrudes from the first sliding pole 21. A rack 224 is defined in an outer side of the second sliding pole 22, along a lengthwise direction of the second sliding pole 22. The clamping portion 222 defines a positioning hole 2221 in an outer surface thereof opposite to the side of the clamping portion 222 where the rack 224 is located.

Each latching member 30 includes a connecting pole 31 perpendicularly extending from a first end thereof, and a latching pole 32 perpendicularly extending from a second end thereof. The connecting pole 31 and the latching pole 32 extend in a same direction. The latching member 30 is made of resilient material, such as metal wire.

The fan 50 includes a rectangular end plate 51. Four corners of the end plate 51 define four installing holes 512.

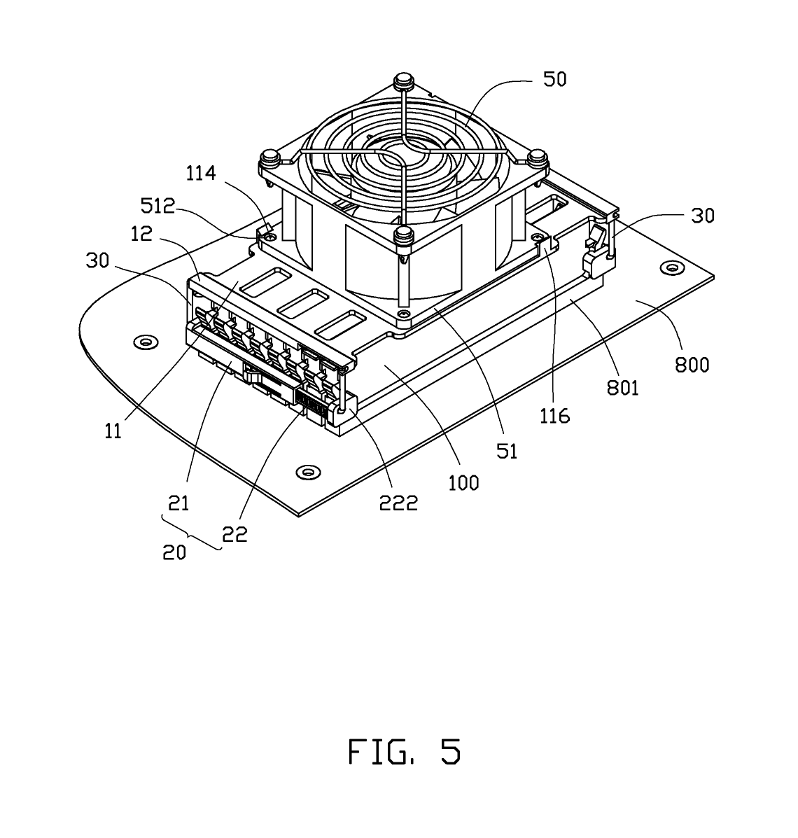

FIG. 5 shows the heat dissipation device assembled and attached to the memory cards 100. First ends of the springs 40 fit around the connecting poles 31 of two of the latching members 30. Second ends of the springs 40 are inserted into the positioning holes 1125 of the supporting bracket 10. Then each of the latching members 30 fitted with the springs 40 is latched in one of the cutouts 1127 of the corresponding mounting portion 12. The spring 40 is limited in the receiving slot 1123, and resiliently abuts against the corresponding latching member 30, to avoid the latching member 30 disengaging from the cutout 1127. The connecting poles 31 of the other two latching members 30 are latched into the mounting holes 121 of the supporting bracket 10. The fan 50 is located above the supporting bracket 10, aligning with the air ventilation area 112. The positioning posts 114 are inserted into and engaged in the installing holes 512 of the fan 50, and the hooks 116 latch two opposite sides of the end plate 51. Thereby, the fan 50 is mounted on the supporting bracket 10.

An end of each second sliding pole 22 opposite to the clamping portion 222 is slidably inserted into the slide slot 215 of the corresponding first sliding pole 21, to allow the latching block 2173 of the first sliding pole 21 to mesh with the rack 224 of the second sliding pole 22. The rack 224 of the second sliding pole 22 can be slid over the guiding surface 2174 of the first sliding pole 21, and can be stopped by the stopping surface 2175 of the latching block 2173. When a distance between the clamping portion 212 of the first sliding pole 21 and the clamping portion 222 of the second sliding pole 22 of each positioning frame 20 needs to be adjusted, the operation portion 2171 is pulled away from the slide slot 215, thereby deforming the resilient arm 217 out. This allows the latching block 2173 to disengage from the rack 224 of the second sliding pole 22, and the second sliding pole 22 to be pulled away from or pushed further into the first sliding pole 21 as required.

In use of the heat dissipation device, the distance between the clamping portions 212 and 222 of each positioning frame 20 is adjusted, until the distance is greater than a width of the plurality of memory slots 801. The positioning frames 20 are attached to opposite ends of the plurality of memory slots 801. The plurality of memory slots 801 are located between the clamping portions 212 and 222 of the positioning frames 20. The second sliding pole 22 of each positioning frame 20 is moved toward the first sliding pole 21, until the clamping portions 212 and 222 of the positioning frame 20 firmly engage with two outmost of the plurality of memory slots 801. Thereby, the positioning frames 20 are mounted to the plurality of memory slots 801. The supporting bracket 10 is supported on the memory cards 100, and the latching poles 32 of the latching members 30 are inserted into the positioning holes 2121 and 2221 of the positioning frames 20. Thereby, the supporting bracket 10 is mounted on the memory cards 100, with the fan 50 aligning with the memory cards 100, for dissipating heat generated by the memory cards 100.

To detach the heat dissipation device, an end of each latching member 30 adjacent to the latching pole 32 is pulled away from the corresponding positioning frame 20, deforming the latching member 30, until the latching pole 32 is disengaged from the corresponding positioning hole 2121 or 2221. The supporting bracket 10 with the fan 50 can then be easily detached from the memory cards 100. The operation portions 2171 of the first sliding poles 21 are pulled away from the expansion cards 801, deforming the resilient arms 217, until the latching blocks 2173 are disengaged from the racks 224 of the second sliding poles 22. The second sliding poles 22 are moved away from the corresponding first sliding poles 21, until the clamping portions 222 disengage from the plurality of memory slots 801.

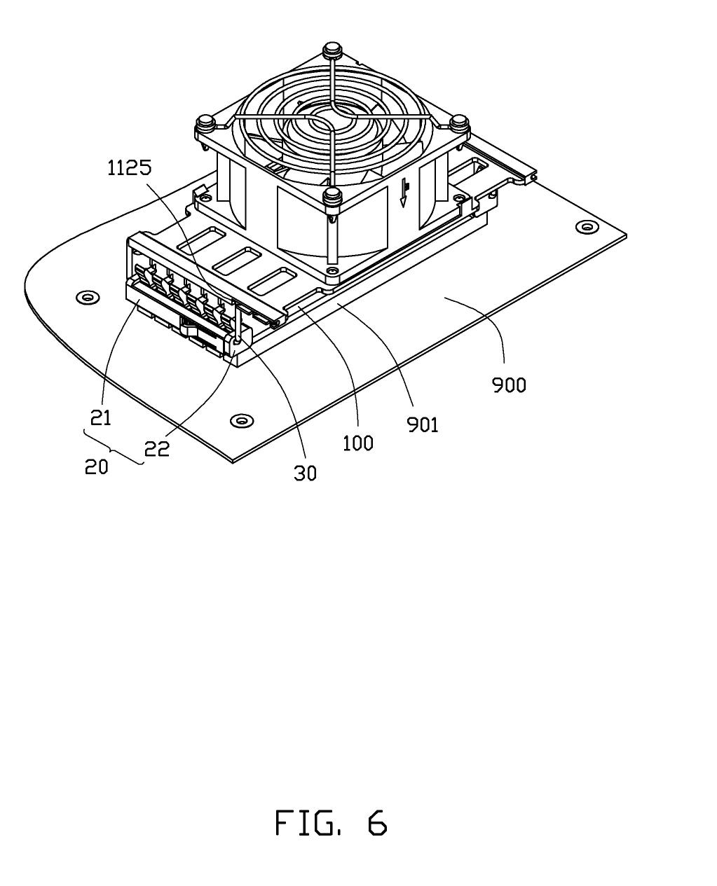

FIG. 6 shows the heat dissipation device is used with another motherboard 900, which has a plurality of memory slots 901. The number of memory slots 901 is less than the number of memory slots 801 of the motherboard 800. For this application with the motherboard 900, the second sliding poles 22 are moved toward the clamping portions 212, until the clamping portions 212 and 222 firmly sandwich the plurality of memory slots 901. The two latching members 30 mounted with the springs 40 are latched into corresponding cutouts 1127, to allow the latching poles 32 to latch in the corresponding positioning holes 2121 and 2221. Thereby, the supporting bracket 10 with the fan 50 is mounted on memory cards 100 connected to the plurality of memory slots 901 of the motherboard 900.

Thus the heat dissipation device is adaptable for use with different motherboards having different arrangements of memory slots and memory cards, such as the motherboard 800 having the memory slots 801 and the memory cards 100 and the motherboard 900 having the memory slots 901 and the memory cards 100.

While the disclosure describes examples and embodiments, it is to be understood that the disclosure is not limited thereto. On the contrary, the disclosure is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A heat dissipation device for a plurality of memory cards connected to a plurality of memory slots, the heat dissipation device comprising:
two positioning frames mounted to opposite ends of the plurality of memory slots;
a supporting bracket located above the memory cards, and comprising a supporting plate defining an air ventilation area aligning with the memory cards, and two mounting portions protruding out from two opposite ends of the supporting plate;
a fan mounted on the supporting plate and aligning with the air ventilation area; and
four latching members;
wherein each mounting portion comprises a first end and a second end opposite to the first end, each latching member comprises a connecting pole and a latching pole which are formed at opposite ends of the latching member, the connecting poles of the latching members are engaged with the first and second ends of the mounting portions of the supporting bracket, and the latching poles of the latching members are engaged with opposite ends of the two positioning frames.

2. The heat dissipation device of claim 1, wherein each positioning frame comprises a first sliding pole and a second sliding pole slidably mounted to the first sliding pole, a first clamping portion protrudes from an end of the first sliding pole away from the second sliding pole, a second clamping portion protrudes from an end of the second sliding pole away from the first sliding pole, a distance between the first and second clamping portions is adjustable to make the first and second clamping portions sandwich the plurality of memory slots, and the latching poles of the latching members are engaged with the first and second clamping portions of the positioning frames.

3. The heat dissipation device of claim 2, wherein each of the first and second clamping portions of each positioning frame defines a positioning hole, and the latching poles of the latching members are latched into the positioning holes of the positioning frames.

4. The heat dissipation device of claim 2, wherein a first end of each mounting portion defines a mounting hole, and an opposite second end of each mounting portion defines a receiving slot extending along a lengthwise direction of the mounting portion, a bottom wall bounding the receiving slot defines a plurality of cutouts arrayed in the lengthwise direction of the mounting portion, the connecting poles of two of the latching members are latched into the mounting holes of the mounting portions, and each of the other two latching members is selectively latched into one of the plurality of cutouts of the corresponding mounting portion.

5. The heat dissipation device of claim 4, wherein the first sliding pole of each positioning frame defines a slide slot extending along a lengthwise direction of the first sliding pole, and the second sliding pole of each positioning frame is slidably inserted in the slide slot of the first sliding pole.

6. The heat dissipation device of claim 5, wherein a resilient arm is formed on each first sliding pole opposite to the side of the first sliding pole from which the clamping portion protrudes, a latching block protrudes from a distal end of the resilient arm into the slide slot, a rack is defined in the corresponding second sliding pole along a sliding direction of the second sliding pole, and the latching block meshes with the rack.

7. The heat dissipation device of claim 6, wherein the latching block comprises a slanting guiding surface slantingly facing the rack of the second sliding pole and a stopping surface perpendicular to the rack of the second sliding pole.

8. The heat dissipation device of claim 4, wherein a spring is received in the receiving slot of each mounting portion, an end of the receiving slot adjacent to the first end of the mounting portion defines a positioning hole communicating with the receiving slot, a first end of the spring is latched in the positioning hole, and an opposite second end of the spring is mounted to the connecting pole of the corresponding latching member.

9. The heat dissipation device of claim 1, wherein the fan comprises an end plate defining four installing holes, and four positioning posts protrude up from the supporting plate and are engaged in the installing holes of the end plate.

10. The heat dissipation device of claim 9, wherein two resilient hooks protrude up from two opposite sides of the supporting plate, and the hooks latch two opposite sides of the end plate.

11. A memory assembly, comprising:
a plurality of memory slots;
a plurality of memory cards connected to the plurality of memory slots;
a supporting bracket located above the memory cards, and comprising a supporting plate and two mounting portions, the supporting plate defining an air ventilation area aligning with the memory cards, and the mounting portions protruding out from two opposite ends of the supporting plate;
two positioning frames mounted to opposite ends of the plurality of memory slots;
a fan mounted on the supporting plate and aligning with the air ventilation area; and
four latching members;
wherein each mounting portion comprises a first end and a second end opposite to the first end, each latching member comprises a connecting pole and a latching pole which are formed at opposite ends of the latching member, the connecting poles of the latching members are engaged with the first and second ends of the mounting portions of the supporting bracket, and the latching poles of the latching members are engaged with opposite ends of the two positioning frames.

12. The memory assembly of claim 11, wherein each positioning frame comprises a first sliding pole and a second sliding pole slidably mounted to the first sliding pole, a first clamping portion protrudes from an end of the first sliding pole away from the second sliding pole, a second clamping portion protrudes from an end of the second sliding pole away from the first sliding pole, the plurality of memory slots are sandwiched between the first clamping portion and the second clamping portion, and the latching poles of the latching members are engaged with the first and second clamping portions of the positioning frames.

13. The memory assembly of claim 12, wherein each of the first and second clamping portions of each positioning frame defines a positioning hole, and the latching poles of the latching members are latched into the positioning holes of the first and second clamping portions of the positioning frames.

14. The memory assembly of claim 12, wherein a first end of each mounting portion defines a mounting hole, and an opposite second end of the mounting portion defines a receiving slot extending along a lengthwise direction of the mounting portion, a bottom wall bounding the receiving slot defines a plurality of cutouts arrayed in the lengthwise direction of the mounting portion, the connecting poles of two of the latching members are latched into the mounting holes of the mounting portions, and each of the other two latching members is selectively latched into one of the plurality of cutouts of the corresponding mounting portion.

15. The memory assembly of claim 14, wherein the first sliding pole of each positioning frame defines a slide slot extending along a lengthwise direction of the first sliding pole, and the second sliding pole of each positioning frame is slidably inserted in the slide slot of the first sliding pole.

16. The memory assembly of claim 15, wherein a resilient arm is formed on each first sliding pole, a latching block protrudes from a distal end of the resilient arm into the slide slot, a rack is defined in the corresponding second sliding pole along a sliding direction of the second sliding pole, and the latching block meshes with the rack.

17. The memory assembly of claim 16, wherein the latching block comprises a slanting guiding surface slantingly extending along the slide direction of the second sliding pole and a stopping surface to engage with the rack of the second sliding pole.

18. The memory assembly of claim 14, wherein a spring is received in the receiving slot of each mounting portion, an end of the receiving slot adjacent to the first end of the mounting portion defines a positioning hole communicating with the receiving slot, a first end of the spring is latched in the positioning hole, and an opposite second end of the spring is mounted to the connecting pole of the corresponding latching member.

19. The memory assembly of claim 11, wherein the fan comprises an end plate defining four installing holes, and four positioning posts protrude up from the supporting plate and are engaged in the installing holes of the end plate.

20. The memory assembly of claim 19, wherein two resilient hooks protrude up from two opposite sides of the supporting plate, and the hooks latch two opposite sides of the end plate.
